(19) United States
(12) Patent Application Publication
(10) Pub. No.: US 2023/0347510 A1
(43) Pub. Date: Nov. 2, 2023

(54) Method for Training a Multi-Task Model Through Multi-Task Reinforcement Learning, Apparatus, Electronic Device, and Storage Medium

(71) Applicant: Horizon Robotics Inc., Cupertino, CA (US)

(72) Inventors: Haichao Zhang, Cupertino, CA (US); Lingfeng Sun, Cupertino, CA (US); Wei Xu, Cupertino, CA (US)

(21) Appl. No.: 17/733,461

(22) Filed: Apr. 29, 2022

(51) Int. Cl. B25J 9/16

(52) U.S. Cl. CPC B25J 9/163; B25J 9/161; B25J 9/1661

(57) ABSTRACT

Disclosed in the present disclosure are a method for training a multi-task model through multi-task reinforcement learning, an apparatus, an electronic device and a non-transitory computer readable storage medium. A method for training a multi-task model through multi-task reinforcement learning, including: acquiring observation signals observed for an environment by an agent; receiving T instructions each for instructing the agent to perform one of T tasks, T being a preset positive integer greater than 1; and generating K base policy models by performing training through multi-task reinforcement learning over a neural network based on the observation signals and the T instructions, wherein the K base policy models are combinable for generating respective task policy models for the T tasks to obtain the multi-task model for achieving the T tasks.

### FIELD OF THE INVENTION

The present disclosure generally relates to a field of machine learning technology, and in particular, to a method for training a multi-task model through multi-task reinforcement learning, apparatus, electronic device, and storage medium.

### BACKGROUND OF THE INVENTION

With development of science and technology, artificial intelligence (AI) is applied more widely. Deep reinforcement learning (RL) has made massive progress in solving complex tasks in different domains. Despite the success of RL in various robotic tasks, most of the improvements are restricted to a single task in locomotion or manipulation. Although many similar tasks with different target and interacting objects are accomplished by the same agent such as a robot, they are usually defined as individual tasks and solved separately. A multi-task reinforcement learning (MTRL) is proposed to train a set of multiple tasks with certain similarities together efficiently. MTRL aims to train an effective policy which can be applied to the same robot to solve different tasks. Compared to training each task separately, a multi-task policy should be efficient in the number of parameters and roll-out environment steps.

The key challenge in multi-task RL methods is determining what should be shared among tasks and how to share. It is reasonable to assume the existence of similarities among all the tasks picked (usually on the same robot) since training completely different tasks together is meaningless. However, the gaps between different tasks can be significant even within the set. For tasks with the same robot but different goals, it's natural to share all the parameters and add the goal into state representation to turn the policy into a goal conditioned policy. For tasks with different skills, sharing policy parameters can be efficient for close tasks but may bring additional difficulties for uncorrelated skills.

### SUMMARY OF THE INVENTION

The present disclosure provides a method for training a multi-task model through multi-task reinforcement learning, an apparatus, an electronic device, a non-transitory computer readable storage medium, and an operating method of the multi-task model trained through the method for training a multi-task model through multi-task reinforcement learning.

According to a first aspect of the present disclosure, there is provided A method for training a multi-task model through multi-task reinforcement learning, including: acquiring observation signals observed for an environment by an agent; receiving T instructions each for instructing the agent to perform one of T tasks, T being a preset positive integer greater than 1; and generating K base policy models by performing training through multi-task reinforcement learning over a neural network based on the observation signals and the T instructions, K being a preset positive integer greater than 1, wherein the K base policy models are combinable for generating respective task policy models for the T tasks to obtain the multi-task model for achieving the T tasks.

According to a second aspect of the present disclosure, there is provided an operating method of the multi-task model trained through the method for training a multi-task model through multi-task reinforcement learning according to embodiments of the present disclosure, including receiving a target instruction for instructing an agent to perform a target task, and determining a group of base policy models for the target task from K base policy models according to the target instruction to obtain a task policy model for the target task from the multi-task model, wherein the task policy model is operable for instructing the agent to perform the target task.

According to a third aspect of the present disclosure, there is provided a non-transitory computer readable storage medium, wherein the non-transitory storage medium stores a computer program, and the computer program is used for implementing the method for training a multi-task model through multi-task reinforcement learning according to embodiments of the present disclosure.

According to a fourth aspect of the present disclosure, there is provided an electronic device, including: a processor; and a memory, configured to store a processor-executable instruction, wherein the processor is configured to read the executable instruction from the memory, and execute the instruction to implement the method for training a multi-task model through multi-task reinforcement learning according to embodiments of the present disclosure.

According to a fifth aspect of the present disclosure, there is provided an apparatus for training a multi-task model through multi-task reinforcement learning, including: acquiring unit for acquiring observation signals observed for an environment by an agent; receiving unit for receiving T instructions each for instructing the agent to perform one of T tasks, T being a preset positive integer greater than 1; training unit for generating K base policy models by performing training through multi-task reinforcement learning over a neural network based on the observation signals and the T instructions, K being a preset positive integer greater than 1, wherein the K base policy models are combinable for generating respective task policy models for the T tasks to obtain the multi-task model for achieving the T tasks.

According to a sixth aspect of the present disclosure, there is provided an operating apparatus of the multi-task model trained through the method for training a multi-task model through multi-task reinforcement learning according to embodiments of the present disclosure, including receiving unit for receiving a target instruction for instructing an agent to perform a target task, and determining unit for determining a group of base policy models for the target task from K base policy models according to the target instruction to obtain a task policy model for the target task from the multi-task model, wherein the task policy model is operable for instructing the agent to perform the target task.

According to the present disclosure, the method for training a multi-task model through multi-task reinforcement learning learns a task-agnostic parameter set forming a subspace in the policy parameter space for all tasks. The task-specific policy in this subspace is inferred by using a compositional vector for each task. Instead of interpolating different policies' output in the action space, the policies in the parameter space are directly composed. In this way, two different tasks can have identical or independent policies. With different sub-space dimensions (i.e., size of parameter set) and additional constraints, this compositional formulation can unify many previous works on sharing structures of MTRL. Moreover, due to clear separation between task-agnostic and task-specific components, it is possible not only to stabilize and improve MTRL, but also to open the door to transfer and continual learning in a natural way. Without resorting to more complicated design or additional data, the proposed method has demonstrated clear improvement over current state-of-the-art methods on standard benchmarks. Furthermore, its possibilities in continual learning have also been demonstrated.

### BRIEF DESCRIPTION OF THE DRAWINGS

By describing the embodiments of the present disclosure more detailed with reference to the accompanying drawings, the foregoing and other objectives, features, and advantages of the present disclosure will become more apparent. The accompanying drawings are provided for further understanding of the embodiments of the present disclosure, constitute a part of the specification, are used to explain the present disclosure together with the embodiments of the present disclosure, and do not constitute limitation to the present disclosure. In the accompanying drawings, same reference numerals generally represent same components or steps.

FIG. 1 is a framework illustrating a scenario for reinforcement learning;

FIG. 2 is a schematic flowchart of a method for training a multi-task model through multi-task reinforcement learning according to an exemplary embodiment of the present disclosure;

FIG. 3 is a schematic diagram illustrating Parameter-Compositional (PaCo) approach used in the method for training a multi-task model through multi-task reinforcement learning according to an exemplary embodiment of the present disclosure;

FIG. 4 is a schematic flowchart of a step of generating K base policy models in the method for training a multi-task model through multi-task reinforcement learning as shown in FIG. 2;

FIG. 5 is a schematic flowchart of a step of performing a training loop in the method for training a multi-task model through multi-task reinforcement learning as shown in FIG. 4;

FIG. 6 is a schematic flowchart of an operating method of a multi-task model trained through a method for training a multi-task model through multi-task reinforcement learning according to an exemplary embodiment of the present disclosure;

FIG. 7 is a schematic flowchart of an operating method of a multi-task model trained through the method for training a multi-task model through multi-task reinforcement learning according to an exemplary embodiment of the present disclosure;

FIG. 8 is a schematic structural diagram of an apparatus for training a multi-task model through multi-task reinforcement learning according to an exemplary embodiment of the present disclosure;

FIG. 9 is a schematic structural diagram of an electronic device according to another exemplary embodiment of the present disclosure.

### DETAILED DESCRIPTION OF THE EMBODIMENTS

Exemplary embodiments of the present disclosure are described below in detail with reference to the accompanying drawings. Obviously, the described embodiments are merely a part, rather than all of embodiments of the present disclosure. It should be understood that the present disclosure is not limited by the exemplary embodiments described herein.

Application Overview

Reinforcement learning (RL) describes a class of problems (and solutions) in which an agent optimizes its control of a system (or “environment”) when the system dynamics are unknown and must be learned by the agent through interaction and observation. A reinforcement learning system can include four main elements—an agent, a policy, a reward and a value function. An agent's behavior at any point of time is defined in terms of a policy.

A policy, π(a, s), is a probabilistic mapping between action a, and state s. Because not all policies are optimal, methods are developed to improve a policy.

The agent interacts with the surrounding environment through a series of actions to obtain environment parameters. For example, as shown in FIG. 1, when performing a task, the agent first performs an action at according to a policy for a state sₜ to interact with the surrounding environment. Under the interaction between action aₜ and the environment, a new state sₜ₊₁ will be generated. Meanwhile, the environment gives a reward rₜ. In this cycle, the agent interacts with its surroundings continuously and thus generates a lot of data. The reinforcement learning algorithm uses the generated data to modify the policy, then interacts with the environment to generate new data, such as rₜ₊₁, sₜ₊₁, and uses the new data to further improve its behavior, and after several iterations of learning, the agent finally learns the optimal policy to complete the corresponding task.

The purpose of multi-task reinforcement learning (MTRL) is to train a single policy that can be applied to a set of different tasks. Sharing parameters allows to take advantage of the similarities among tasks. However, the gaps between contents and difficulties of different tasks bring us challenges on both which tasks should share the parameters and what parameters should be shared.

Exemplary Method

In view of the above, inventors introduce a parameter-compositional (PaCo) approach to address these challenges. In this framework, a policy subspace represented by a set of parameters is learned. Policies for all the single tasks lie in this subspace and can be composed by interpolating with the learned set.

An embodiment of the present disclosure provides a method for training a multi-task model through MTRL to solve the above issues effectively.

Generally, the method learns a task-agnostic parameter set forming a subspace in the policy parameter space for all tasks. The task-specific policy in this subspace is inferred by using a compositional vector for each task. Instead of interpolating different policies' output in the action space, the policies in the parameter space are directly composed. In this way, two different tasks can have identical or independent policies on two extremes, while having different degrees of parameter-sharing therebetween. With different sub-space dimensions (i.e., size of parameter set) and additional constraints, this compositional formulation can unify many previous works on sharing structures of MTRL. Moreover, keeping a task-agnostic parameter set brings advantages in extending trained policies to unseen tasks.

After the basic principles of the present disclosure are introduced, various non-limiting embodiments of the present disclosure are described in detail below with reference to the accompanying drawings.

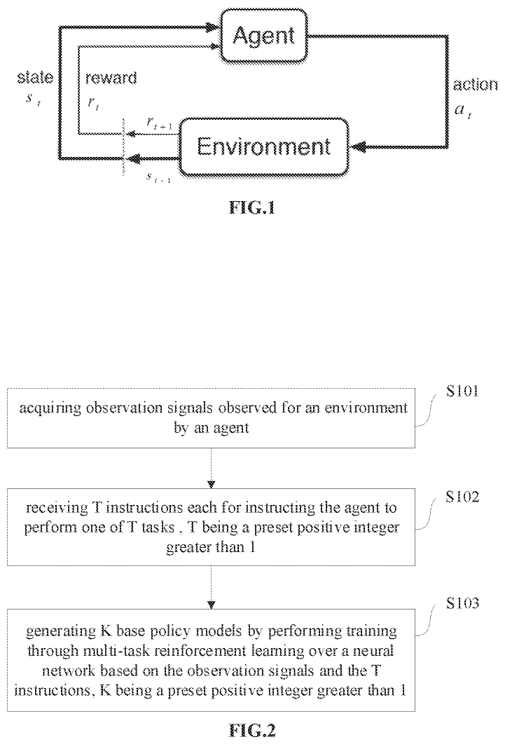

FIG. 2 is a schematic flowchart of a method for training a multi-task model through multi-task reinforcement learning according to an exemplary embodiment of the present disclosure. As shown in FIG. 2, the following steps are included.

Step S101. acquiring observation signals observed for an environment by an agent

In this embodiment, the observation signals may be observed for the environment by the agent through sensory devices.

The term “agent” may refer to any man-made entity that chooses actions in response to observations, including for example but not limited to a robot, to a simulated robot, and to a software agent or “bot” and the like.

The terms “observation” refers to any information the agent receives by any means about the agent's environment or itself, and the term “observation signals” refers to any signals carrying the information. In some embodiments, the information may be sensory information sensed or observed through sensory devices, such as without limitation cameras, touch sensors, range sensors, temperature sensors, wavelength sensors, sound or speech sensors, position sensors, pressure or force sensors, velocity or acceleration or other motion sensors, location sensors (e.g., GPS), etc. In other embodiments that information could also include without limitation compiled, abstract, or situational information compiled from a collection of sensory devices combined with stored information. In a non-limiting example, the agent may receive as observation abstract information regarding the location or characteristics of itself or other objects around it. In some embodiments, observation may be information about internal parts of the agent, such as without limitation proprioceptive information or other information regarding the agent's current or past actions, information about the agent's internal state, or information already computed or processed by the agent.

Step S102. receiving T instructions each for instructing the agent to perform one of T tasks, T being a preset positive integer greater than 1.

Each task may be achieved through performing a plurality of actions by the agent interacting with the environment.

The instruction could be an instruction converted from a voice command, such as a voice command given by a user to control a robotic arm to perform a “button press” or “door open” operation. In addition, the instruction may be an instruction triggered by other operations, such as mechanical operation.

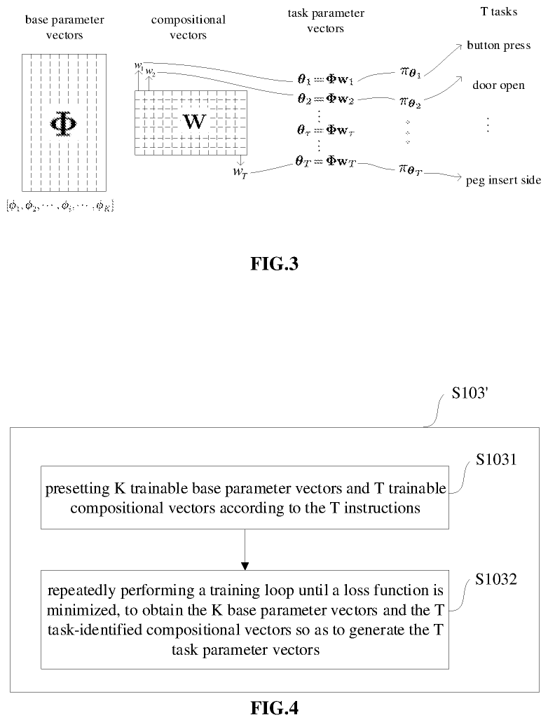

The tasks may include, but is not limited to, the above-mentioned “button press” or “door open”, but can also include more operations, such as drawer close, peg insert side, drawer open, pick place, push, reach, window open and window close, etc., as shown in FIG. 3, which is a schematic diagram illustrating PaCo approach used in the method for training a multi-task model through multi-task reinforcement learning according to an exemplary embodiment of the present disclosure.

Step S103. generating K base policy models by performing training through multi-task reinforcement learning over a neural network based on the observation signals and the T instructions, K being a preset positive integer greater than 1.

A Parameter-Compositional approach to MTRL is presented herein. The K base policy models are combinable for generating respective task policy models for the T tasks to instantiate the multi-task model for achieving the T tasks. In the embodiment, K base policy models may be represented by a shared parameter set across tasks, and may be combined according to instructions for the T tasks to generate respective task policy models for the T tasks, so that to achieve each of T tasks.

The method provided in this embodiment may generate the K base policy models by performing training through multi-task reinforcement learning over the neural network based on the observation signals and the T instructions, so that when learning multiple tasks, it is not necessary to train a separate network model for each task, and the K base policy models are obtained by training the T tasks collectively, which contains the shared parameters needed for achieving all tasks. Because shared parameters are used selectively by different tasks, conflicts in multitasking training are reduced, thus addressing the two disadvantages mentioned above.

In the embodiments of the present disclosure, for the neural network, Soft Actor-Critic (SAC) may be used to train the K base policy models for the multi-task RL problem. SAC is an off-policy actor-critic method that uses the maximum entropy framework. The parameters in SAC framework include the policy network π(aₜ|sₜ) used in evaluation, the critic network Q(sₜ, aₜ) as a soft Q-function. The policy and critic function optimization procedure remains the same as the single-task setting.

In an embodiment of the present disclosure, S103 may include S103′ of generating a first parameter set and a second parameter set by performing training through multi-task reinforcement learning over the neural network based on the observation signals and the T instructions.

The first parameter set includes first parameters shared across tasks, and the second parameter set includes second parameters for identifying the T tasks corresponding to the T instructions.

Upon the training, the first parameter set is generated from the first parameters to include K base parameter groups and the second parameter set is generated from the second parameters to include T task-identified parameter groups, each of the K base parameter groups being for instantiating the base policy model, and each of the T task-identified parameter groups being for combining the first parameters in the first parameter set.

Wherein the K base parameter groups in the first parameter set are combinable by the second parameter set for generating T task parameter groups each for instantiating a corresponding one of the respective task policy models for the T tasks to obtain the multi-task model for achieving the T tasks.

Specifically, a PaCo framework may be formulated for MTRL as follows.

Given a task τ˜T, where τ denotes the set of tasks with |τ|=T, θ_{τ}∈ [symbol] ^{a} is used to denote the vector of all the trainable parameters of the model (i.e., policy and critic networks) for task τ. The task parameter vector is decomposed according to Eqn. (1):

θ_{τ}=Φw_{τ} (1)

where Φ=[ϕ₁, ϕ₂, . . . , ϕᵢ, . . . , ϕ_{K}]∈ [symbol] ^{a/K} denotes a matrix formed by a set of K parameter vectors {ϕᵢ}ᵢ₌₁^{K} (referred to as parameter set, which is also overloaded for referring to Φ), each of which has the same dimensionality as θ_{τ}, i.e., ϕᵢ∈ [symbol] ^{a}, wᵣ∈ [symbol] ^{K} is a compositional vector, which is implemented as a trainable embedding vector for the task index τ. A model with parameters in the form of Eqn.(1) is referred to as a PaCo model.

The final output of PaCo framework is a parameter set D of K groups of parameters and the compositional vector w_{τ} for each skill. Since any relation between tasks did not be known in advance and all skills are deemed as equivalent ones, the compositional vectors are directly learned by PaCo without any additional supervisions apart from the reinforcement signal.

In the presence of a single task, the decomposition in Eqn.(1) brings no additional benefits, as it is essentially equivalent to the standard way of parameterizing the model. However, when faced with multiple tasks, as in the MTRL setting considered in this work, the decomposition in Eqn.(1) offers opportunities for tackling the challenges posed by the MTRL setting. More concretely, Eqn.(1) decomposes the parameters to two parts: i) task-agnostic Φ and ii) task-aware w_{τ}. The task-agnostic Φ can be shared across all the tasks, while still ensure task awareness via w_{τ}, leading to:

[θ₁, . . . , θ_{τ}, . . . , θ_{T}]=Φ[w₁, . . . , w_{τ}, . . . w_{T}]

Θ=≮W (2)

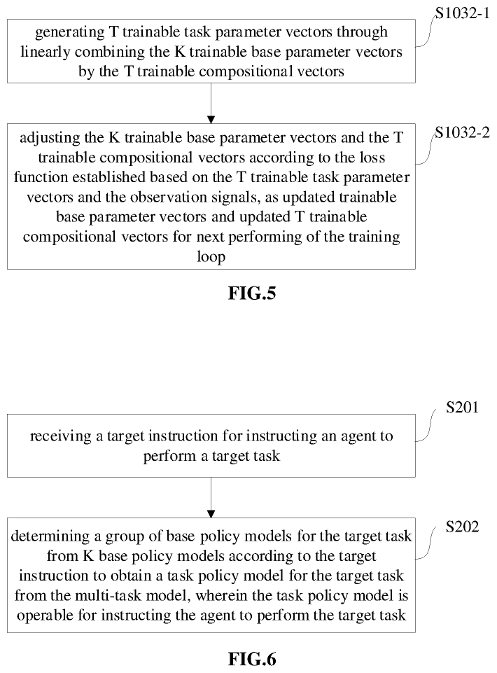

In an embodiment of the present disclosure, the step S103′ may include a step S1031 of presetting K trainable base parameter vectors and T trainable compositional vectors according to the T instructions, as shown FIG. 4, which is a schematic flowchart of a step of generating K base policy models in the method for training a multi-task model through multi-task reinforcement learning as shown in FIG. 2.

In an embodiment, the K trainable base parameter vectors {ϕᵢ}ᵢ₌₁^{K} and the T trainable compositional vectors {wᵢ}ᵢ₌₁^{T} may be preset with the respective initial vectors for training.

For PaCo, K trainable base parameter vectors Φ with identical structure may be initialized. Other than separately initializing all the parameters, one of the K trainable base parameter vectors or layers may be randomly initialized, and weights may be copied to the other K−1 layers. With the identical initialization on Φ, all task-specific parameters θ_{τ} may be identical regardless the initialization of W_{τ}. Experiments show that PaCo can find interpolated policies faster with identical initialization of parameter set.

The step S103′ may further include a step S1032 of repeatedly performing a training loop until a loss function is minimized, to obtain the K base parameter vectors and the T task-identified compositional vectors so as to generate the T task parameter vectors.

In an embodiment, as shown FIG. 5, which is a schematic flowchart of a step of performing a training loop in the method for training a multi-task model through multi-task reinforcement learning as shown in FIG. 4, the performing of the training loop includes: a step S1032-1 of generating T trainable task parameter vectors through linearly combining the K trainable base parameter vectors by the T trainable compositional vectors; and a step S1032-2 of adjusting the K trainable base parameter vectors and the T trainable compositional vectors according to the loss function established based on the T trainable task parameter vectors and the observation signals, as updated trainable base parameter vectors and updated T trainable compositional vectors for next performing of the training loop.

In this embodiment, the task parameter vector θ_{τ} for a task τ is instantiated in a compositional form based on the shared base parameter set Φ and the task-specific compositional vector w_{τ}. Then the networks are used in consideration of the observation signals in the standard way for generating actions or computing the loss. During training, the shared base parameter set Φ will be impacted by all the task losses, while the task-specific compositional vector W_{τ} is impacted by the corresponding task loss only.

For MTRL, let Jᵣ(θ) denote the summation of both actor and critic losses implemented in the same way as in SAC for task τ, the multi-task loss is defined as the summation of individual loss J_{τ} across tasks:

J_{Θ} [symbol] Σ_{τ}J_{τ}(θ)

where Θ denotes the collection of all the trainable parameters of both actor and critic networks. Together with Eqn.(2), it can be observed that the multi-task loss J_{Θ} contributes to the learning of the model parameters in two ways:
[symbol] J_{Θ}/ [symbol] Φ=Σ_{τ} [symbol] J_{τ}/ [symbol] Φ: all the T tasks will contribute to the learning of the shared parameter set Φ;
[symbol] J_{Θ}/ [symbol] W=Σ_{τ} [symbol] J_{τ}/ [symbol] w_{τ}: each task loss J₆₇₃ will only impact its own task specific compositional vector w_{τ}.

Furthermore, because of the clear separation between task-specific and task-agnostic information, the compositional form of parameters as in Eqn.(2) offers opportunities to naturally handle several cases (e.g. continual learning, transfer learning etc.) beyond standard MTRL. For example, in the case of transfer learning, the task-agnostic parameter set Φ can be transferred to serve as the pre-trained policy basis for further learning.

In one training loop, the trainable task parameter vectors are adjusted using the multi-task loss function to obtain adjustment vectors Δθ for the trainable task parameter vectors for decreasing the multitask loss (i.e., increases the reward). Respective adjustment vectors for the trainable base parameter vectors and the trainable compositional vectors may be inferred according to Eqn. (2) and adjustment vectors for the trainable task parameter vectors, to generate updated trainable base parameter vectors and updated trainable compositional vectors for next performing of the training loop. The training loop is performed repeatedly until the loss function is minimized, to obtain the K base parameter vectors and the T task-identified compositional vectors so as to generate the T task parameter vectors for achieving the multiple tasks.

The inherent challenge in MTRL is the interferences during training among tasks due to parameter sharing. One consequence of this is that the failure of training on one task may adversely impact the training of other tasks. To mitigate this issue, a prior approach is adopting an empirical trick to stop and discard the whole training once this issue is spotted. Due to the PaCo approach, the method according to the present disclosure may mitigate this issue without resorting to more complicated design or additional data.

More specifically, once a task loss J_{η} surpasses some threshold E, because of the clear separation of task-specific parameters from shared parameters Φ, the method according to an embodiment of the present disclosure can straightforwardly mask out J_{η} from the total loss J to avoid its adverse impacts on others, which will essentially freeze w_{η} and contribute no gradients to D, which is referred to as the Freeze. This is a conservative scheme which largely stabilizes the training but can compromise the overall performance of the final policy as it has reduced opportunity of learning on the masked-out tasks.

Due to the compositional natural of the PaCo model, a potential is provided to reach an better effect, than pure Freeze. This can be achieved by re-initializing w_{η} without impacting parameters of all others, in additional to loss mask out as in Reset, and then keep training as normal. One way is to re-initialize w_{η} as:

$$\text{?} = \text{?} {β}_{j} {w}_{j} , \qquad ( 3 )$$

$$β = [ {β}_{1} , {β}_{2} , … ] ∼ \text{?}$$

$$\text{?} \text{indicates text missing or illegible when filed}$$

where V [symbol] {j|Jⱼ≤ϵ}, and β is uniformly sampled from a unit |V|−1-simplex Δ^{|V|-1}.

This scheme may be referred as Reset. Compared with Freeze, which essentially stops training on the problematic task, Reset offers an opportunity of further learning on that task. It is worthwhile to point out that the ability to use Reset-like schemes is a unique feature of PaCo, due to its clear separation between task-agnostic and task-specific parameters. Previous methods cannot employ this due to the lack of clear decomposition between the two parts. Empirical results show that this can improve the training and lead to better model performance The overall procedure of PaCo is presented in Algorithm 1.

Algorithm 1 Parameter-Compositional MTRL (PaCo)

Input: param-set size K, loss threshold ∈, learning rate λ
while termination condition is not satisfied do

| | |
|---|---|
| θ_{τ} = Φw_{τ} | [symbol] compose task parameter vector |
| J_{τ} ← J_{τ}(θ) | [symbol] loss (actor + critic as in SAC) across |
| | tasks |

(Freeze / Reset Step 1) J_{η} ← 0 if J_{η} > ∈

| | |
|---|---|
| J_{Θ} ← Σ_{τ} J_{τ} | [symbol] calculate multi-task loss |
| Φ ← Φ − λ∇_{Φ}J_{Θ} | [symbol] parameter set update |

for each task τ do

| | |
|---|---|
| w_{τ} ← w_{τ} − λ∇_{w}_{_{τ}} J_{τ}(w_{τ}) | [symbol] composition param update |

```
  end for
  (Reset Step 2) w [symbol]  ← Eqn.(3) if J_{η} > ∈
end while [symbol]
indicates data missing or illegible when filed
```

The method according to embodiments of the present may be applied flexibly to some existing models or methods.

Apart from the interesting compositional form and the features of PaCo, it also provides a unified perspective on viewing some existing methods. Using this formulation, it is possible to re-derive some existing methods with specific instantiations of Φ and w.

Single-Task Model: if setting Φ=[ϕ₁, ϕ₂ . . . ] and w_{τ} as a one-hot task-id vector, this essentially instantiates a singletask model, i.e. each task has its dedicated parameters.

Multi-Task Model: if setting Φ=[ϕ]∈ [symbol] ^{n×1}, w1=w2= . . . =1, then all the tasks share the same parameter vector θ^{τ}=ϕ. By taking state and the task-id as input, the multi-task model may be instantiated.

Multi-Head Multi-Task Model: by setting Φ as follows:

$$Φ = [ \begin{matrix}{ϕ}^{′} & {ϕ}^{′} & … & {ϕ}^{′} & … & {ϕ}^{′} \\ {ψ}_{1} & {ψ}_{2} & … & \text{?} & … & {ψ}_{K}\end{matrix} ] ∈ {ℝ}^{n \times K}$$

$$\text{?} \text{indicates text missing or illegible when filed}$$

where Ψ_{τ} is the sub-parameter-vector of the output layer for task τ. Setting w_{τ} as a one-hot task-id vector, the multi-head model for MTRL may be recovered, where all the tasks share the same trunk network parameterized by ϕ′ with independent head Ψ^{τ} for each task τ.

Soft-Modularization is the case where Φ is in a specially structured form, with the combination done at each level with a “per-level” soft combination vector z(s, τ) conditioned on current state s and task-id τ.

$${θ}_{τ} = [ \begin{matrix}[ {ϕ}_{1}^{1} & {ϕ}_{2}^{1} & … & {ϕ}_{K}^{1} ] {z}^{1} ( s , τ ) \\ & & ⋮ & \\ {ϕ}_{1}^{m} & {ϕ}_{2}^{m} & … & {ϕ}_{K}^{m} ] {z}^{m} ( s , τ )\end{matrix} ]$$

A difference is that Soft-Modularization applies the combination on the activation instead of parameters. Nevertheless, the dependency of the combination vector z(s, τ) on states makes it diffuse task relevant and task agnostic information together, therefore all the parameters are entangled with state information and is less flexible in some cases, e.g., continuing training on new tasks.

Going beyond MTRL, the unique property of a well separated task-agnostic parameter set and task-specific compositional vector provide a potential to use PaCo in a more challenging continual setting. The main reason for catastrophic forgetting in continual learning is that the training on new tasks modifies the policies of existing tasks. However, in the PaCo framework according to the present disclosure, when the policies for new task τ may be found in the existing policy subspace defined by Φ with a new compositional vector w_{τ}, the forgetting problem can be avoided. With no change on Φ, the existing parameters may be extended to a new task with no additional cost. In experiments, when the skills are similar, successful extensions from existing skill set to a new skill may be found. For instance, reach, door-open, drawer-open to drawer-close.

In practice, a more general training scheme can is designed to learn the policy for a series of tasks. Given a parameter set Φ with K parameter groups trained on T tasks, when the policy for new tasks in the policy subspace is found, the compositional vector for the new task may be saved; and when the policy in subspace cannot be found, the new tasks on a new parameter set Φ may be trained and merged into subspace with higher dimension. Verifying this property on larger skill sets is an interesting future direction and requires more complex experiment designs.

Based on a revisit to MTRL and its challenges both within and beyond its typical settings, PaCo, a simple parameter compositional approach is presented as a way to mitigates some of these challenges.

The proposed approach has the benefits of clear separation between task-agnostic and task-specific components, which is not only useful for stabilizing and improving MTRL, but also opens the door to transfer and continual learning in a natural way. Without resorting to more complicated design or additional data, PaCo has demonstrated clear improvement over current state-of-the-art methods on standard benchmarks. Furthermore, its possibilities in continual learning have also been demonstrated.

Through the method for training a multi-task model through multi-task reinforcement learning according to exemplary embodiments of the present disclosure, a multi-task model may be obtained, including T task policy models each for a corresponding one of the T tasks, wherein each task policy model is obtained through combining K base policy models according to a corresponding one of T instructions for the T tasks, and is operable for instructing an agent to perform the corresponding task.

According to embodiments of the present disclosure, an operating method of a multi-task model trained through a method for training a multi-task model through multi-task reinforcement learning according to exemplary embodiments of the present disclosure is described as follows.

According to an embodiment of the present disclosure, as shown in FIG. 6, an operating method of a multi-task model trained through a method for training a multi-task model through multi-task reinforcement learning may include:

Step S201. receiving a target instruction for instructing an agent to perform a target task, and

Step S202. determining a group of base policy models for the target task from K base policy models according to the target instruction to obtain a task policy model for the target task from the multi-task model, wherein the task policy model is operable for instructing the agent to perform the target task.

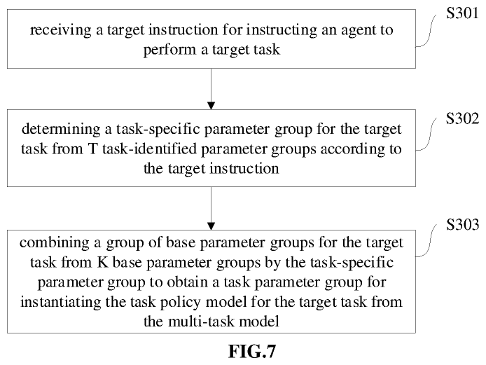

According to an embodiment of the present disclosure, as shown in FIG. 7, an operating method of a multi-task model trained through a method for training a multi-task model through multi-task reinforcement learning may include:

Step S301. receiving a target instruction for instructing an agent to perform a target task;

Step S302. determining a task-specific parameter group for the target task from T task-identified parameter groups according to the target instruction; and

Step S303. combining a group of base parameter groups for the target task from K base parameter groups by the task-specific parameter group to obtain a task parameter group for instantiating the task policy model for the target task from the multi-task model, wherein the task policy model is operable for instructing the agent to perform the target task.

According to an embodiment of the present disclosure, an operating method of a multi-task model trained through a method for training a multi-task model through multi-task reinforcement learning may include: receiving a target instruction for instructing an agent to perform a target task; determining a task-specific compositional vector for the target task from T task-identified compositional vectors according to the target instruction; and linearly combining a group of base parameter vectors for the target task from K base parameter vectors by the task-specific compositional vector to obtain a task-specific parameter vector for instantiating the task policy model for the target task from the multi-task model, wherein the task policy model is operable for instructing the agent to perform the target task.

The embodiments of the present disclosure can be applied to various scenarios in the field of artificial intelligence, including automatic driving scenarios, industrial robot automation control and other scenarios that can be implemented.

This scenario involves hardware and software environments, among which the hardware environment includes an agent. Optionally, the agent can be a computing entity with stereoscopic perception, full-domain collaboration, accurate judgment, continuous evolution and open intelligent system, such as autonomous driving vehicles, robots and mechanical arms.

In addition, the hardware environment also includes a variety of sensors, such as gyroscope sensors, distance sensors, light sensors, gravity sensors, etc., these sensors are used for real-time acquisition of ambient parameters, or to sense the current state of an agent. Optionally, various sensors can be installed on or outside the agent and connected to the agent.

The software environment can be a variety of software operating platforms for inputting control instructions and output instructions to agents.

Exemplary Apparatus

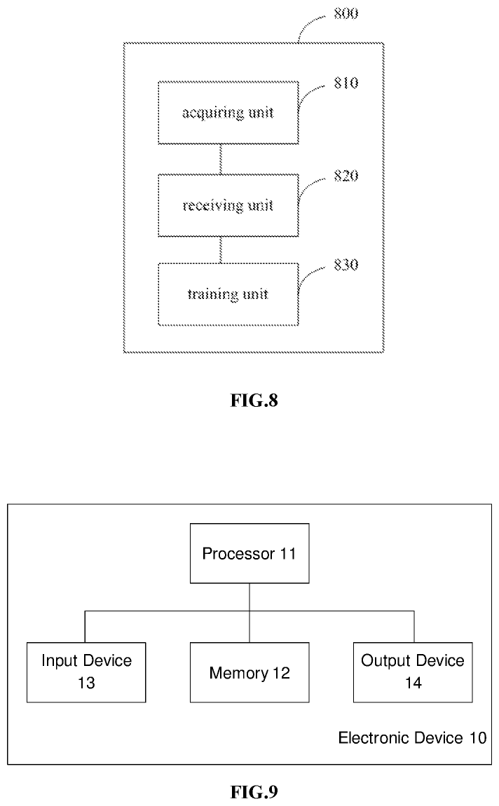

FIG. 8 is a schematic structural diagram of an apparatus for training a multi-task model through multi-task reinforcement learning according to an exemplary embodiment of the present disclosure. As shown in FIG. 8, an apparatus 800 for training a multi-task model through multi-task reinforcement learning, including:
an acquiring unit 810 for acquiring observation signals observed for an environment by an agent;
a receiving unit 820 for receiving T instructions each for instructing the agent to perform one of T tasks, T being a preset positive integer greater than 1;
a training unit 830 for generating K base policy models by performing training through multi-task reinforcement learning over a neural network based on the observation signals and the T instructions, K being a preset positive integer greater than 1.
wherein the K base policy models are combinable for generating respective task policy models for the T tasks to obtain the multi-task model for achieving the T tasks.

In an embodiment, the training unit 830 is used for generating a first parameter set and a second parameter set by performing training through multi-task reinforcement learning over the neural network based on the observation signals and the T instructions, wherein the first parameter set includes first parameters shared across tasks, and the second parameter set includes second parameters for identifying the T tasks corresponding to the T instructions.

Upon the training, the first parameter set is generated from the first parameters to include K base parameter groups and the second parameter set is generated from the second parameters to include T task-identified parameter groups, each of the K base parameter groups being for instantiating the base policy model, and each of the T task-identified parameter groups being for combining the first parameters in the first parameter set.

Furthermore, the K base parameter groups in the first parameter set are combinable by the second parameter set for generating T task parameter groups each for instantiating a corresponding one of the respective task policy models for the T tasks to obtain the multi-task model for achieving the T tasks.

In an embodiment, the K base parameter groups in the first parameter set are matrixed to correspond to K base parameter vectors, respectively, the T task-identified parameter groups in the second parameter set are matrixed to correspond to T task-identified compositional vectors, respectively, and the T task parameter groups are matrixed to correspond to T task parameter vectors, respectively.

The training unit 830 is used for presetting K trainable base parameter vectors and T trainable compositional vectors according to the T instructions; and repeatedly performing a training loop until a loss function is minimized, to obtain the K base parameter vectors and the T task-identified compositional vectors so as to generate the T task parameter vectors.

Furthermore, for the performing of the training loop, the training unit 830 may generate T trainable task parameter vectors through linearly combining the K trainable base parameter vectors by the T trainable compositional vectors; adjust the K trainable base parameter vectors and the T trainable compositional vectors according to the loss function established based on the T trainable task parameter vectors and the observation signals, as updated trainable base parameter vectors and updated T trainable compositional vectors for next performing of the training loop.

It should be noted that the foregoing various modules may be implemented by software code, or may be implemented by hardware such as a logic gate circuit or an integrated circuit chip, or may also be implemented in a form of a combination of hardware and software.

Herein, a person skilled in the art may understand that specific functions and operations of modules in the foregoing apparatus 800 for training a multi-task model through multi-task reinforcement learning have been described in detail in the description of the data processing method in the foregoing method embodiments. Therefore, repeated description may be omitted herein.

Exemplary Electronic Device

FIG. 10 is a block diagram of an electronic device according to an embodiment of the present disclosure.

As shown in FIG. 10, an electronic device 10 includes one or more processors 11 and a memory 12.

The processor 11 may be a central processing unit (CPU) or another form of processing unit, such as a graphics processing unit (GPU), having a data processing capability and/or an instruction execution capability, and may control another component in the electronic device 10 to perform a desired function. The processor includes an operating unit and one or more buffers. The specific structure has been described in detail in the foregoing exemplary processor, and details are not repeated herein.

The memory 12 may include one or more computer program products. The computer program product may include various forms of computer readable storage media, such as a volatile memory and/or a non-volatile memory. The volatile memory may include, for example, a random access memory (RAM), a cache and/or the like. The nonvolatile memory may include, for example, a read-only memory (ROM), a hard disk, a flash memory and the like. One or more computer program instructions may be stored on the computer readable storage medium.

The program instruction may be executed by the processor 11, to implement the data processing method according to the foregoing method embodiments described above and/or other desired functions. Various contents such as an input signal, a signal component, and a noise component may also be stored on the computer readable storage medium.

In an example, the electronic device 10 may further include an input device 13 and an output device 14. These components are interconnected with each other through a bus system and/or another form of connection mechanism (not shown).

When the electronic device is a computer device, the input device 13 may be a communication network connector for receiving network data. In addition, the input device 13 may further include, for example, a keyboard, a mouse and so on. The output device 14 may include, for example, a display, a loudspeaker, a printer, a communication network, a remote output device connected by the communication network, and so on.

Certainly, for simplicity, FIG. 10 shows only some of components in the electronic device 10 that are related to the present disclosure, and components such as a bus and an input/output interface are omitted. In addition, according to specific application situations, the electronic device 10 may further include any other appropriate components.

Exemplary Computer Program Product And Computer-Readable Storage Medium

In addition to the foregoing method and device, the embodiments of the present disclosure may further relate to a computer program product, which includes a computer program instruction. When executing the computer program instruction, the processor is enabled to perform the steps, of the data processing method according to the embodiments of the present disclosure, that are described in the “exemplary method” part of this specification.

The computer program product may be program code, written with one or any combination of a plurality of programming languages, that is configured to perform the operations in the embodiments of the present disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of the present disclosure may further relate to a computer-readable storage medium, which stores a computer program instruction. When executing the computer program instruction, the processor is enabled to perform the steps, of the data processing method according to the embodiments of the present disclosure, that are described in the “exemplary method” part of this specification.

The computer-readable storage medium may be one readable medium or any combination of a plurality of readable media. The readable medium may be a readable signal medium or a readable storage medium. The readable storage medium may include, for example, but is not limited to electricity, magnetism, light, electromagnetism, infrared ray, or a semiconductor system, apparatus or device, or any combination of the above. More specific examples (a non-exhaustive list) of the readable storage medium include: an electrical connection with one or more conducting wires, a portable disk, a hard disk, a random access memory (RAM), a read-only memory (ROM), an erasable programmable read-only memory (EPROM or flash memory) or a flash memory, an optical fiber, a portable compact disk read-only memory (CD-ROM), an optical storage device, a magnetic storage device, or any suitable combination of the above.

Basic principles of the present disclosure are described above in combination with the specific embodiments. However, it should be pointed out that the advantages, superiorities, and effects mentioned in the present disclosure are merely illustrative but are not for limitation, and it cannot be considered that these advantages, superiorities, and effects are necessary for each embodiment of the present disclosure. In addition, specific details of the above disclosure are merely for examples and for ease of understanding, rather than limitations. The foregoing details do not limit that the present disclosure must be implemented by using the foregoing specific details.

The block diagrams of the equipment, the apparatus, the device, and the system involved in the present disclosure are merely exemplary examples and are not intended to require or imply that the equipment, the apparatus, the device, and the system must be connected, arranged, and configured in the manners shown in the block diagrams. It is recognized by a person skilled in the art that, the equipment, the apparatus, the device, and the system may be connected, arranged, and configured in an arbitrary manner. The terms such as “include”, “contain”, and “have” are open terms that mean “including but not limited to”, and may be used interchangeably with “including but not limited to”. The terms “or” and “and” used herein refer to the term “and/or”, and may be used interchangeably with “and/or”, unless the context clearly indicates otherwise. The term “such as” used herein refers to the phrase “such as but not limited to”, and may be used interchangeably with “such as but not limited to”.

It should be further pointed out that, various components or various steps in the apparatus, the device, and the method of the present disclosure may be disassembled and/or recombined. These disassembled and/or recombined components or steps shall be regarded as equivalent solutions of the present disclosure.

The foregoing description about the disclosed aspects is provided, so that the present disclosure can be arrived at or carried out by any person skilled in the art. Various modifications to these aspects are very obvious to a person skilled in the art. Moreover, general principles defined herein may be applicable to other aspects without departing from the scope of the present disclosure. Therefore, the present disclosure is not intended to be limited to the aspect illustrated herein, but to the widest scope consistent with the principles and novel features disclosed herein.

The foregoing description has been given for illustration and description. In addition, this description is not intended to limit the embodiments of the present disclosure to be in forms disclosed herein. Although a plurality of exemplary aspects and embodiments have been discussed above, a person skilled in the art may recognize certain variations, modifications, changes, additions, and sub-combinations thereof.

What is claimed is:

1. A method for training a multi-task model through multi-task reinforcement learning, including:
acquiring observation signals observed for an environment by an agent;
receiving T instructions each for instructing the agent to perform one of T tasks, T being a preset positive integer greater than 1; and
generating K base policy models by performing training through multi-task reinforcement learning over a neural network based on the observation signals and the T instructions, K being a preset positive integer greater than 1,
wherein the K base policy models are combinable for generating respective task policy models for the T tasks to obtain the multi-task model for achieving the T tasks.

2. The method according to claim 1, wherein the generating of K base policy models includes:
generating a first parameter set and a second parameter set by performing training through multi-task reinforcement learning over the neural network based on the observation signals and the T instructions, wherein the first parameter set includes first parameters shared across tasks, and the second parameter set includes second parameters for identifying the T tasks corresponding to the T instructions,
wherein upon the training, the first parameter set is generated from the first parameters to include K base parameter groups and the second parameter set is generated from the second parameters to include T task-identified parameter groups, each of the K base parameter groups being for instantiating the base policy model, and each of the T task-identified parameter groups being for combining the first parameters in the first parameter set, and
wherein the K base parameter groups in the first parameter set are combinable by the second parameter set for generating T task parameter groups each for instantiating a corresponding one of the respective task policy models for the T tasks to obtain the multi-task model for achieving the T tasks.

3. The method according to claim 2, wherein the K base parameter groups in the first parameter set are matrixed to correspond to K base parameter vectors, respectively, the T task-identified parameter groups in the second parameter set are matrixed to correspond to T task-identified compositional vectors, respectively, and the T task parameter groups are matrixed to correspond to T task parameter vectors, respectively.

4. The method according to claim 3, wherein the generating of the first parameter set and the second parameter set by performing training through multi-task reinforcement learning over the neural network based on the observation signals and the T instructions includes:
presetting K trainable base parameter vectors and T trainable compositional vectors according to the T instructions; and
repeatedly performing a training loop until a loss function is minimized, to obtain the K base parameter vectors and the T task-identified compositional vectors so as to generate the T task parameter vectors.

5. The method according to claim 4, wherein the performing of the training loop includes:
generating T trainable task parameter vectors through linearly combining the K trainable base parameter vectors by the T trainable compositional vectors; and
adjusting the K trainable base parameter vectors and the T trainable compositional vectors according to the loss function established based on the T trainable task parameter vectors and the observation signals, as updated trainable base parameter vectors and updated T trainable compositional vectors for next performing of the training loop.

6. The method according to claim 5, wherein the environment and the agent are from virtual scenarios or real scenarios.

7. An operating method of a multi-task model trained through the method of claim 1, including:
receiving a target instruction for instructing an agent to perform a target task, and
determining a group of base policy models for the target task from K base policy models according to the target instruction to obtain a task policy model for the target task from the multi-task model, wherein the task policy model is operable for instructing the agent to perform the target task.

8. The operating method according to claim 7, wherein the determining of K base policy models for the target task from K base policy models according to the target instruction to obtain the task policy model includes:
determining a task-specific parameter group for the target task from T task-identified parameter groups according to the target instruction; and
combining a group of base parameter groups for the target task from K base parameter groups by the task-specific parameter group to obtain a task parameter group for instantiating the task policy model for the target task from the multi-task model, wherein the task policy model is operable for instructing the agent to perform the target task,
wherein each of the K base parameter groups is for instantiating the base policy model.

9. The operating method according to claim 8,
wherein the K base parameter groups are matrixed to correspond to K base parameter vectors, respectively, the T task-identified parameter groups are matrixed to correspond to T task-identified compositional vectors, respectively, and the T task parameter groups are matrixed to correspond to T task parameter vectors, respectively,
wherein the determining of the task-specific parameter group includes determining a task-specific compositional vector for the target task from the T task-identified compositional vectors according to the target instruction; and
wherein the combining of the group of base parameter groups includes: linearly combining a group of base parameter vectors for the target task from the K base parameter vectors by the task-specific compositional vector to obtain a task-specific parameter vector for instantiating the task policy model for the target task from the multi-task model, wherein the task policy model is operable for instructing the agent to perform the target task.

10. A non-transitory computer readable storage medium, wherein the non-transitory storage medium stores a computer program, and the computer program is used for implementing a method for training a multi-task model through multi-task reinforcement learning, wherein the method includes:
acquiring observation signals observed for an environment by an agent;
receiving T instructions each for instructing the agent to perform one of T tasks, T being a preset positive integer greater than 1; and
generating K base policy models by performing training through multi-task reinforcement learning over a neural network based on the observation signals and the T instructions, K being a preset positive integer greater than 1,
wherein the K base policy models are combinable for generating respective task policy models for the T tasks to obtain the multi-task model for achieving the T tasks.

11. The non-transitory computer readable storage medium according to claim 10, wherein the generating of K base policy models includes:
generating a first parameter set and a second parameter set by performing training through multi-task reinforcement learning over the neural network based on the observation signals and the T instructions, wherein the first parameter set includes first parameters shared across tasks, and the second parameter set includes second parameters for identifying the T tasks corresponding to the T instructions,
wherein upon the training, the first parameter set is generated from the first parameters to include K base parameter groups and the second parameter set is generated from the second parameters to include T task-identified parameter groups, each of the K base parameter groups being for instantiating the base policy model, and each of the T task-identified parameter groups being for combining the first parameters in the first parameter set, and
wherein the K base parameter groups in the first parameter set are combinable by the second parameter set for generating T task parameter groups each for instantiating a corresponding one of the respective task policy models for the T tasks to obtain the multi-task model for achieving the T tasks.

12. The non-transitory computer readable storage medium according to claim 11, wherein the K base parameter groups in the first parameter set are matrixed to correspond to K base parameter vectors, respectively, the T task-identified parameter groups in the second parameter set are matrixed to correspond to T task-identified compositional vectors, respectively, and the T task parameter groups are matrixed to correspond to T task parameter vectors, respectively.

13. The non-transitory computer readable storage medium according to claim 12, wherein the generating of the first parameter set and the second parameter set by performing training through multi-task reinforcement learning over the neural network based on the observation signals and the T instructions includes:
presetting K trainable base parameter vectors and T trainable compositional vectors according to the T instructions; and
repeatedly performing a training loop until a loss function is minimized, to obtain the K base parameter vectors and the T task-identified compositional vectors so as to generate the T task parameter vectors.

14. The non-transitory computer readable storage medium according to claim 13, wherein the performing of the training loop includes:
generating T trainable task parameter vectors through linearly combining the K trainable base parameter vectors by the T trainable compositional vectors; and
adjusting the K trainable base parameter vectors and the T trainable compositional vectors according to the loss function established based on the T trainable task parameter vectors and the observation signals, as updated trainable base parameter vectors and updated T trainable compositional vectors for next performing of the training loop.

15. An electronic device, including:
a processor; and
a memory, configured to store a processor-executable instruction, wherein
the processor is configured to read the executable instruction from the memory, and execute the instruction to implement a method for training a multi-task model through multi-task reinforcement learning, wherein the method includes:
acquiring observation signals observed for an environment by an agent;
receiving T instructions each for instructing the agent to perform one of T tasks, T being a preset positive integer greater than 1; and
generating K base policy models by performing training through multi-task reinforcement learning over a neural network based on the observation signals and the T instructions, K being a preset positive integer greater than 1,
wherein the K base policy models are combinable for generating respective task policy models for the T tasks to obtain the multi-task model for achieving the T tasks.

16. The electronic device according to claim 15, wherein the generating of K base policy models includes:
generating a first parameter set and a second parameter set by performing training through multi-task reinforcement learning over the neural network based on the observation signals and the T instructions, wherein the first parameter set includes first parameters shared across tasks, and the second parameter set includes second parameters for identifying the T tasks corresponding to the T instructions,
wherein upon the training, the first parameter set is generated from the first parameters to include K base parameter groups and the second parameter set is generated from the second parameters to include T task-identified parameter groups, each of the K base parameter groups being for instantiating the base policy model, and each of the T task-identified parameter groups being for combining the first parameters in the first parameter set, and
wherein the K base parameter groups in the first parameter set are combinable by the second parameter set for generating T task parameter groups each for instantiating a corresponding one of the respective task policy models for the T tasks to obtain the multi-task model for achieving the T tasks.

17. The electronic device according to claim 16, wherein the K base parameter groups in the first parameter set are matrixed to correspond to K base parameter vectors, respectively, the T task-identified parameter groups in the second parameter set are matrixed to correspond to T task-identified compositional vectors, respectively, and the T task parameter groups are matrixed to correspond to T task parameter vectors, respectively.

18. The electronic device according to claim 17, wherein the generating of the first parameter set and the second parameter set by performing training through multi-task reinforcement learning over the neural network based on the observation signals and the T instructions includes:
presetting K trainable base parameter vectors and T trainable compositional vectors according to the T instructions; and
repeatedly performing a training loop until a loss function is minimized, to obtain the K base parameter vectors and the T task-identified compositional vectors so as to generate the T task parameter vectors.

19. The electronic device according to claim 18, wherein the performing of the training loop includes:
generating T trainable task parameter vectors through linearly combining the K trainable base parameter vectors by the T trainable compositional vectors; and
adjusting the K trainable base parameter vectors and the T trainable compositional vectors according to the loss function established based on the T trainable task parameter vectors and the observation signals, as updated trainable base parameter vectors and updated T trainable compositional vectors for next performing of the training loop.

20. The electronic device according to claim 19, wherein the environment and the agent are from virtual scenarios or real scenarios.
